(19) United States
(12) Patent Application Publication
(10) Pub. No.: US 2024/0402398 A1
(43) Pub. Date: Dec. 5, 2024

(54) LIGHT FLUX CONTROLLING MEMBER AND METAL MOLD

(71) Applicant: Enplas Corporation, Saitama (JP)

(72) Inventors: Takahiro IZAWA, Saitama (JP); Yuki SAITO, Saitama (JP); Satoshi OSHIMA, Saitama (JP)

(73) Assignee: Enplas Corporation, Saitama (JP)

(21) Appl. No.: 18/672,108

(22) Filed: May 23, 2024

(30) Foreign Application Priority Data
May 29, 2023 (JP) 2023-087773
Nov. 14, 2023 (JP) 2023-193673

(51) Int. Cl. G02B 3/08; B29D 11/00; G02B 5/30; G02B 27/09

(52) U.S. Cl. CPC G02B 3/08; B29D 11/00519; G02B 5/3083; G02B 27/0955; B29K 2905/12

(57) ABSTRACT

A light flux controlling member of the present invention includes: a vortex surface including a plurality of phase control surfaces having a vortex shape around a central axis and radially divided with the central axis at a center, and a plurality of step surfaces each configured to connect end portions of adjacent two phase control surfaces of the plurality of phase control surfaces. Upper sides of the plurality of step surfaces intersect each other at a center portion of the vortex surface. In side view, a curve extending from the center portion toward an outer periphery part of the vortex surface has an inflection point at the center portion of the vortex surface.

This application claims the benefit of priority of Japanese Patent Application No. 2023-087773, filed on May 29, 2023, and Japanese Patent Application No. 2023-193673, filed on Nov. 14, 2023, the disclosure of which including in this specification, drawings and abstract is incorporated herein by reference in its entirety.

### TECHNICAL FIELD

The present invention relates to a light flux controlling member, and a metal mold for molding the light flux controlling member.

### BACKGROUND ART

In recent years, communication apparatuses and systems equipped with multimode optical fibers have been used to transmit and receive large volumes of data at high speeds through optical communications. Multimode optical fibers have a larger diameter core through which light can pass than single-mode optical fibers. In optical communications using such multimode optical fibers, back reflection, where light is reflected at the end surface of the optical fiber and returns towards the light source, is a problem. This is because when reflected light returns to the light source, a phenomenon known as returned light noise occurs, which causes fluctuations in the output of the light source.

As a means of improving this problem, it is known to use optical elements called vortex lenses and vortex phase plates (e.g. PTL 1). A vortex lens (vortex phase plate) is an optical element (light flux control member) having a vortex surface including a vortex-shaped phase control surface and a step surface connecting the end portions of the phase control surface. When light having a Gaussian distribution with high intensity in the central part (Gaussian beam) is passed through the vortex lens, it is converted into light having a ring-shaped intensity distribution (vortex beam) with a significantly reduced intensity in the central part. PTL 1 discloses that by injecting light with a ring-shaped intensity distribution generated using a vortex lens into the multimode optical fiber, the back-reflected light is less likely to reach the light source.

NPLS 1 and 2 disclose optical communications using vortex phase masks with functions similar to those of vortex lenses. NPLS 1 and 2 achieve vortex phase masks by using spatial light modulators. NPL 1 uses phase masks with topological charge numbers 1 of +4, +8, −8, and +16. NPL 2 uses phase masks with topological charge numbers 1 of 1, 2, 3 and 4.

### CITATION LIST

### Patent Literature

PTL 1
Japanese Patent Application Laid-Open No. 2016-091014

### Non Patent Literature

NPL 1
Jian Wang, et al., “Terabit free-space data transmission employing orbital angular momentum multiplexing”, Nature Photonics, Vol. 6, pp. 488-496.
NPL 2
Zikun Wang, “Efficient Recognition of the Propagated Orbital Angular Momentum Modes in Turbulences With the Convolutional Neural Network”, IEEE Photonics Journal, Vol. 11, 7903614.

### SUMMARY OF INVENTION

### Technical Problem

As disclosed in NPLS 1 and 2, phase masks with various topological charge numbers are known. In view of this, the present inventors attempted to manufacture vortex lenses with various topological charge numbers. FIGS. 1A to 1C are diagrams illustrating examples of phase patterns with respective different topological charge numbers 1, and FIGS. 1D to 1F are diagrams illustrating shapes of vortex surfaces that can form light with appropriate ring-shaped intensity distributions with the phase patterns illustrated in FIGS. 1A to 1C and center portions that are not crushed. More specifically, FIG. 1D is a diagram illustrating a shape of a vortex surface with the phase pattern (l=1) illustrated in FIG. 1A, FIG. 1E is a diagram illustrating a shape of a vortex surface with the phase pattern (l=2) illustrated in FIG. 1B, and FIG. 1F is a diagram illustrating a shape of a vortex surface with the phase pattern (l=4) illustrated in FIG. 1C.

When optical elements such as lenses are manufactured with metal molds, the surface of the metal mold for molding the optical surface is generally formed by cutting. In view of this, the present inventor formed, by means of cutting, a surface (hereinafter referred to as “vortex surface molding surface”) for molding a vortex surface of a metal mold for molding a vortex lens. When vortex lenses with the vortex surfaces (1>2) illustrated in FIGS. 1E and 1F were manufactured by using metal molds obtained in the above-described manner, the center portions of the vortex surfaces were crushed. With such vortex lenses, light with the ring-shaped intensity distribution was not appropriately formed due to the unintended center shape.

An object of the present invention is to provide a light flux controlling member that includes a vortex surface with a plurality of phase control surfaces and can appropriately form light with a ring-shaped intensity distribution. In addition, another object of the present invention is to provide a metal mold for molding the above-described light flux controlling member.

### Solution to Problem

The present invention relates to a light flux controlling member, and a metal mold for molding the light flux controlling member described below.
[1] A light flux controlling member including: a vortex surface including a plurality of phase control surfaces having a vortex shape around a central axis and radially divided with the central axis at a center, and a plurality of step surfaces each configured to connect end portions of adjacent two phase control surfaces of the plurality of phase control surfaces. Upper sides of the plurality of step surfaces intersect each other at a center portion of the vortex surface. In side view, a curve extending from the center portion toward an outer periphery part of the vortex surface has an inflection point at the center portion of the vortex surface.
[2] The light flux controlling member according to [1], in which a shortest distance between an extension of an upper side of each of the plurality of step surfaces and the central axis, and a shortest distance between an extension of a lower side of each of the plurality of step surfaces and the central axis are both 5 μm or smaller.
[3] The light flux controlling member according to [1] or [2], in which the number of the plurality of phase control surfaces is the same as a topological charge number of the vortex surface.
[4] The light flux controlling member according to any one of [1] to [3], in which the plurality of phase control surfaces has the same shape.
[5] The light flux controlling member according to any one of [1] to [4], in which the plurality of phase control surfaces is disposed in a same height range.
[6] A metal mold for molding a light flux controlling member, the light flux controlling member including: a vortex surface including a plurality of phase control surfaces having a vortex shape around a central axis and radially divided with the central axis at a center, and a plurality of step surfaces each configured to connect end portions of adjacent two phase control surfaces of the plurality of phase control surfaces. Upper sides of the plurality of step surfaces intersect each other at a center portion of the vortex surface. In side view, a curve extending from the center portion toward an outer periphery part of the vortex surface has an inflection point at the center portion of the vortex surface.

### Advantageous Effects of Invention

According to the present invention, it is possible to provide a light flux controlling member with a vortex surface including a plurality of phase control surfaces that can appropriately form light with a ring-shaped intensity distribution.

### BRIEF DESCRIPTION OF DRAWINGS

FIGS. 1A to 1C are diagrams illustrating examples of phase patterns with different topological charge numbers, and FIGS. 1D to 1F are diagrams illustrating shapes of vortex surfaces having the phase patterns illustrated in FIGS. 1A to 1C;

FIG. 2 is a sectional view illustrating a configuration of a metal mold according to the embodiment;

FIG. 3A is a bottom view of the metal mold (lower mold) according to the embodiment, and FIG. 3B is a sectional view taken along line A-A of FIG. 3A;

FIG. 4A is a perspective view illustrating a state where a metal mold is manufactured by using a known cutting tool, and FIG. 4B is a perspective view illustrating a state where a metal mold is manufactured by using a cutting tool according to the embodiment;

FIG. 5 is a photograph of a region near the center of the vortex surface of a trial product of a vortex lens having the vortex surface illustrated in FIG. 1D;

FIG. 6 is a photograph of the metal mold (vortex surface molding surface) according to the embodiment;

FIG. 7 is a photograph of the metal mold (vortex surface molding surface) according to the embodiment;

FIG. 8 is a flowchart of a manufacturing method of a light flux controlling member according to the embodiment;

FIG. 9 is a perspective view of the light flux controlling member according to the embodiment;

FIG. 10A is a plan view of the light flux controlling member according to the embodiment, FIG. 10B is a front view, right view, rear view and left view of the light flux controlling member according to the embodiment, and FIG. 10C is a sectional view taken along line B-B and line C-C of FIG. 10A;

FIG. 11 is a photograph of a region near the center of the vortex surface of the light flux controlling member according to the embodiment;

FIG. 12A is a diagram illustrating an intensity distribution of light emitted from a light flux controlling member having a vortex surface with a crushed center portion, and FIG. 12B is a diagram illustrating an intensity distribution of light emitted from the light flux controlling member according to the embodiment; and

FIGS. 13A and 13B are schematic plan views illustrating a vortex surface of a light flux controlling member of which the topological charge number 1 is four.

### DESCRIPTION OF EMBODIMENTS

An embodiment according to the present invention is elaborated below with reference to the accompanying drawings.

### Metal Mold and Manufacturing Method of The Same

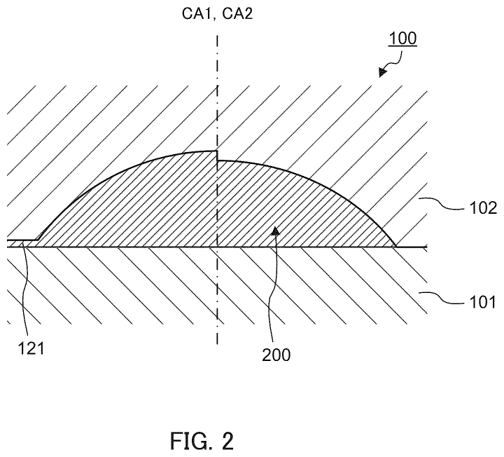

First, metal mold 100 according to an embodiment of the present invention is described. As illustrated in FIG. 2, metal mold 100 is used for molding light flux controlling member 200 according to the embodiment of the present invention.

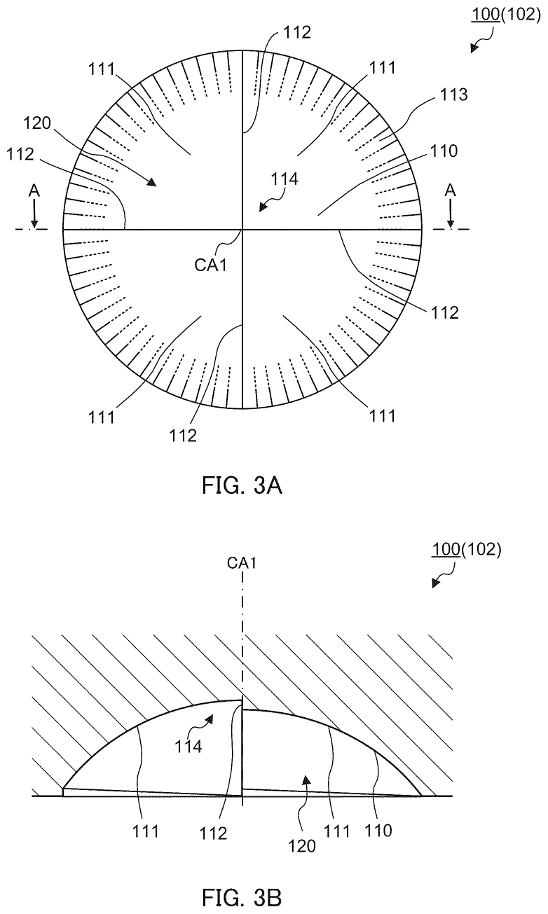

FIGS. 2, 3A and 3B illustrate a configuration of metal mold 100. As illustrated in FIG. 2, metal mold 100 includes upper mold 101 and lower mold 102. Cavity 120 and gate 121 are formed with upper mold 101 and lower mold 102. FIGS. 3A and 3B illustrate only a piece (lower mold 102) including vortex surface molding surface 110 in metal mold 100. FIG. 3A is a bottom view of metal mold 100 (lower mold 102), and FIG. 3B is a sectional view taken along line A-A of FIG. 3A. In FIGS. 3A and 3B, gate 121 is omitted.

As illustrated in FIGS. 3A and 3B, metal mold 100 includes vortex surface molding surface 110 and cavity 120.

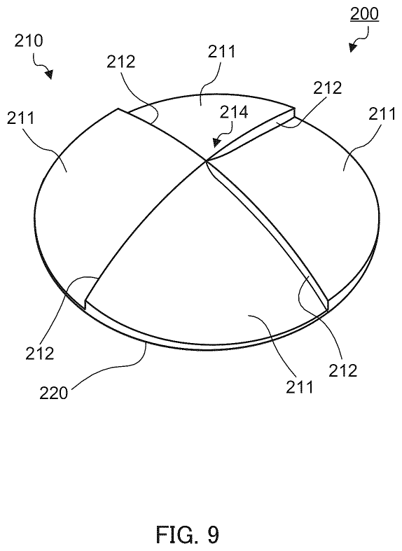

Vortex surface molding surface 110 is a surface for molding vortex surface 210 of light flux controlling member 200. As described later, vortex surface (which is also referred to as light vortex generation surface) 210 of light flux controlling member 200 includes a plurality of phase control surfaces 211 having a vortex shape around central axis CA2 of light flux controlling member 200 and radially divided with respect to central axis CA2 at the center, and a plurality of step surfaces 212 that connects the end portions of adjacent two phase control surfaces 211 in the plurality of phase control surfaces 211 (see FIG. 9). Vortex surface molding surface 110 has a shape complementary to vortex surface 210, and includes a plurality of phase control surface molding surfaces 111 having a vortex shape around central axis CA1 of metal mold 100 and radially divided with respect to central axis CA1 at the center, and a plurality of step surface molding surfaces 112 that connects the end portions of adjacent two phase control surface molding surfaces 111 in the plurality of phase control surface molding surfaces 111. Note that “radially divide” as used herein means dividing an object such that a plurality of dividing lines extends radially from one point in plan view. A region generated by the dividing has a fan-shape.

Each of the plurality of phase control surface molding surfaces 111 is a surface for molding phase control surface 211 of light flux controlling member 200. The plurality of phase control surfaces 211 of light flux controlling member 200 has a vortex shape around central axis CA2 of light flux controlling member 200 (see FIG. 9), and thus the plurality of phase control surface molding surfaces 111 of metal mold 100 has a vortex shape around central axis CA1 of metal mold 100. The number of the plurality of phase control surface molding surfaces 111 is the same as the number of the plurality of phase control surfaces 211 of light flux controlling member 200. In the example illustrated in FIG. 3A, vortex surface molding surface 110 includes four phase control surface molding surfaces 111. The plurality of (four) phase control surfaces molding surfaces 111 is disposed to be symmetric (4-fold rotational symmetric) around central axis CA1 of metal mold 100. Thus, the plurality of (four) phase control surfaces molding surfaces 111 has the same shape, and is disposed in the same height range. Here, the height in metal mold 100 means the position in the direction along central axis CA1.

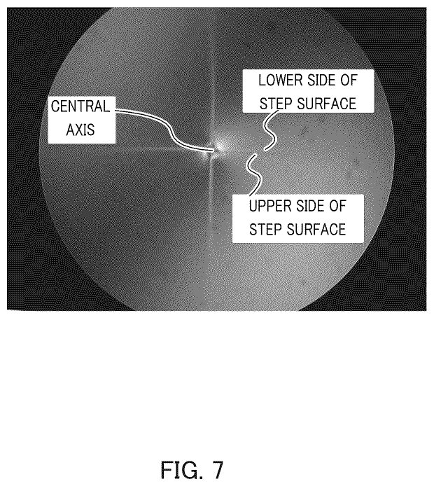

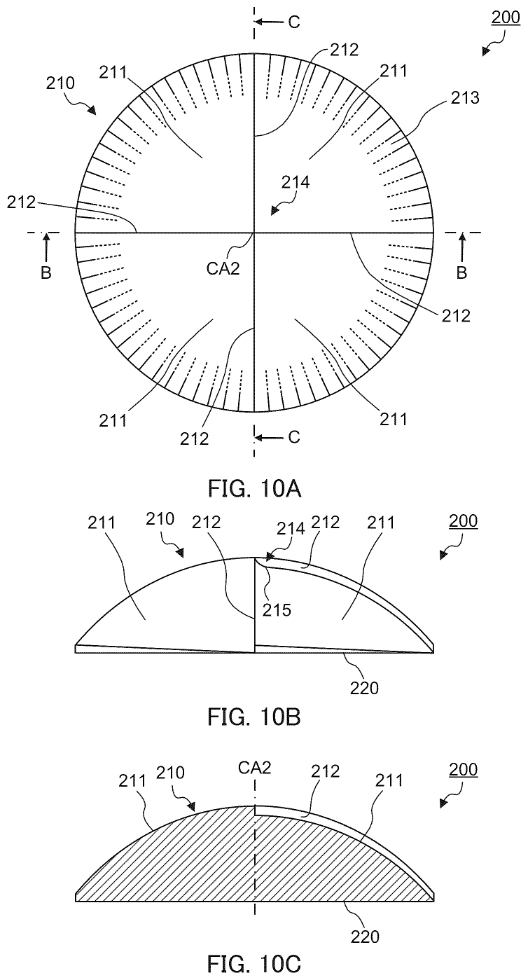

The plurality of step surface molding surfaces 112 are surfaces for molding step surface 212 of light flux controlling member 200. The plurality of step surfaces 212 of light flux controlling member 200 each connect the end portions of adjacent two phase control surfaces 211 (see FIG. 9), and therefore the plurality of step surface molding surfaces 112 of metal mold 100 each connect the end portions of adjacent two phase control surface molding surfaces 111. In addition, the plurality of step surfaces 212 of light flux controlling member 200 is flat surfaces extending in the radial direction to the outer edge from central axis CA2 of light flux controlling member 200 (see FIG. 7), and therefore the plurality of step surface molding surfaces 112 of metal mold 100 is flat surfaces extending in the radial direction to the outer edge from central axis CA1 of metal mold 100. The number of the plurality of step surface molding surfaces 112 is the same as the number of the plurality of phase control surfaces 211 of light flux controlling member 200 and the number of the plurality of phase control surface molding surfaces 111 of metal mold 100. In the example of the present embodiment, vortex surface molding surface 110 includes four step surface molding surfaces 112. The plurality of (four) step surface molding surfaces 112 are disposed to be symmetric (4-fold rotational symmetric) around central axis CA1 of metal mold 100. Thus, the plurality of (four) step surface molding surfaces 112 has the same shape, and is disposed in the same height range. Note that in the following description, regarding the sides of step surface molding surface 112, the side corresponding to the upper side of step surface 212 of light flux controlling member 200 is the upper side of step surface molding surface 112, and the side corresponding to the lower side of step surface 212 of light flux controlling member 200 is the lower side of step surface molding surface 112. Light flux controlling member 200 includes first surface 220 for allowing incidence of light from the light source or emitting to the outside light travelled inside, and vortex surface (second surface) 210 for emitting to the outside light entered from first surface 220 or allowing incidence of light (see FIGS. 10B and 10C). In this specification, first surface 220 side (light source side) of light flux controlling member 200 is the lower direction, and vortex surface 210 side of light flux controlling member 200 is the upward direction (see FIGS. 10B and 10C). As such, the upper side of step surface 212 of light flux controlling member 200 is farther from first surface 220 (light source side surface) than the lower side of step surface 212 of light flux controlling member 200.

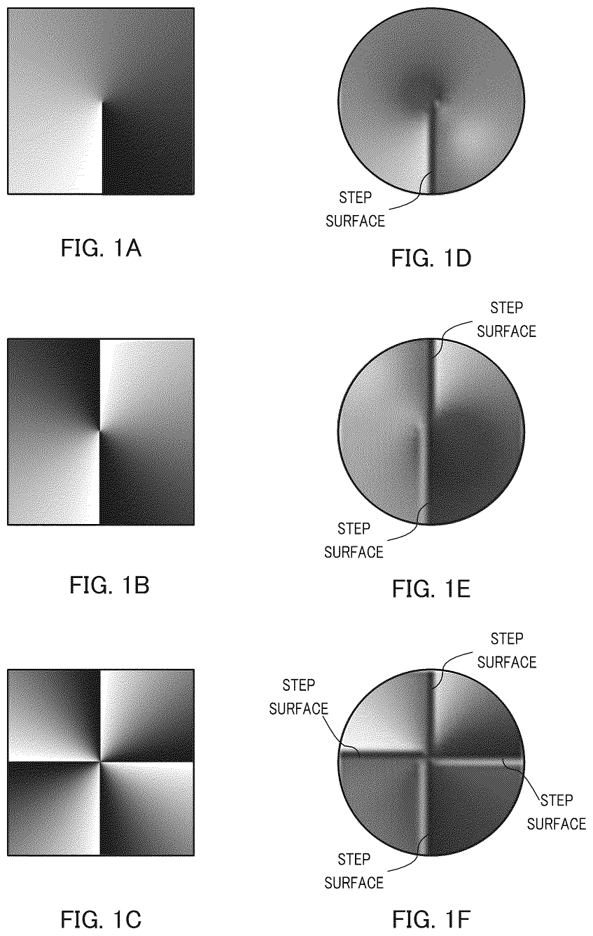

FIG. 1F illustrates an example of preferable vortex surface 210. As illustrated in FIG. 1F, phase control surface 211 between two step surfaces 212 in the circumferential direction is preferably a gentle, continuous surface, more preferably a mirror surface.

If vortex surface molding surface 110 of metal mold 100 is formed through concentric cutting as with known common processing methods, annular machining marks are formed. As a result, annular machining marks are formed also in vortex surface 210 of light flux controlling member 200. The machining marks are formed not only in the outer periphery part, but also in the center portion in vortex surface 210. In the case where the machining marks are formed in the center portion of vortex surface 210 in the above-described manner, the upper sides of the plurality of step surfaces 212 do not intersect at the center portion of vortex surface 210. Light flux controlling member 200 with such machining marks at the center portion of vortex surface 210 cannot appropriately form light with a ring-shaped intensity distribution due to unintended machining marks.

In view of this, in the present embodiment, vortex surface molding surface 110 of metal mold 100 is formed by performing radial cutting. In this case, in the outer periphery part of vortex surface molding surface 110, radial working grooves (machining marks) 113 are slightly formed in some situation as illustrated in FIG. 3A. On the other hand, in center portion 114 of vortex surface molding surface 110, the processing regions overlap each other such that the same region is repeatedly processed, and thus working grooves 113 are eliminated. In this manner, center portion 114 of vortex surface molding surface 110 is formed as a substantially mirrored surface. In addition, the upper sides of the plurality of step surface molding surfaces 112 intersect each other at center portion 114 of vortex surface molding surface 110. As a result, center portion 214 of vortex surface 210 of light flux controlling member 200 is also formed as a substantially mirrored surface, and the upper sides of the plurality of step surfaces 212 intersect at the center portion of vortex surface 210, and thus, light with a ring-shaped intensity distribution can be appropriately formed. Note that center portion 114 of vortex surface molding surface 110 as used herein means the distance range from central axis CA1 of vortex surface molding surface 110 (metal mold 100) to 1/10 of the radius of vortex surface molding surface 110. Likewise, center portion 214 of vortex surface 210 as used herein means the distance range from central axis CA2 of vortex surface 210 (light flux controlling member 200) to 1/10 of the radius of vortex surface 210.

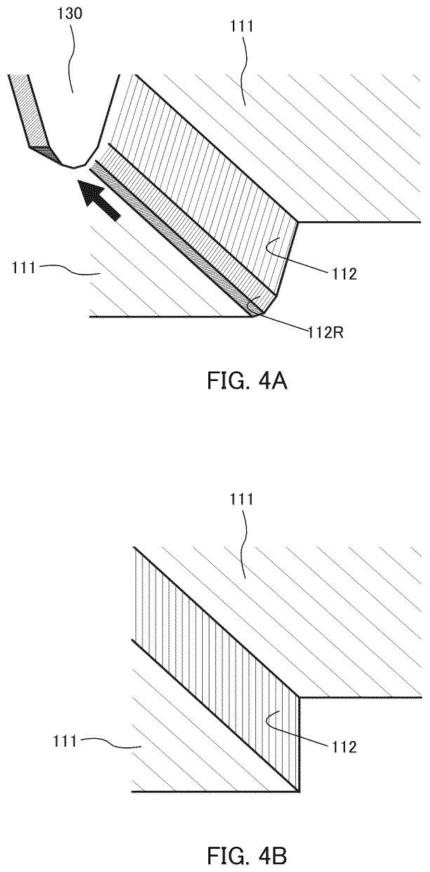

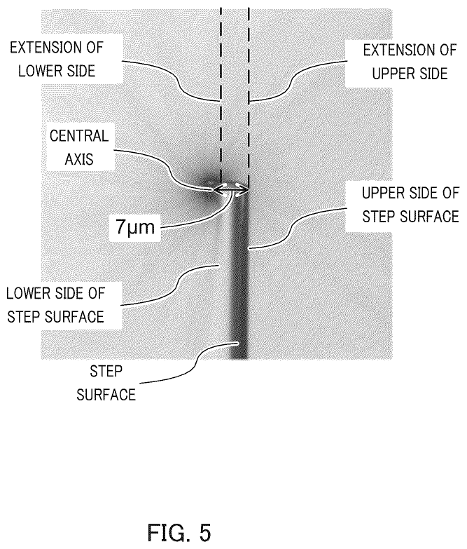

In addition, if known common cutting tool 130 is used when performing the radial cutting process of vortex surface molding surface 110 of metal mold 100, curved surface (R surface) 112R is formed at the boundary between phase control surface molding surface 111 and step surface molding surface 112 at the upper end of step surface molding surface 112 (the portion corresponding to the upper side of step surface molding surface 112) as illustrated in FIG. 4A. As a result, the position of the upper side of step surface molding surface 112 and the position of the lower side of step surface molding surface 112 are largely shifted from each other in the horizontal direction, and at least one of the upper side and lower side of step surface molding surface 112 is separated away from central axis CA1 of metal mold 100. Consequently, if light flux controlling member 200 is manufactured with metal mold 100 formed with known common cutting tool 130, at least one of the shortest distance between the extension of the upper side of step surface 212 of light flux controlling member 200 and central axis CA2 of light flux controlling member 200, and the shortest distance between the extension of the lower side of step surface 212 of light flux controlling member 200 and central axis CA2 of light flux controlling member 200 becomes 7 μm or greater as illustrated in FIG. 5. Specifically, step surface 212 that should be radially extended from central axis CA2 in design is formed at a position separated from central axis CA2. Such light flux controlling member 200 cannot appropriately form light with a ring-shaped intensity distribution due to the unintended shape of step surface 212. Note that FIG. 5 illustrates vortex surface 210 with one step surface 212 for the sake of clearly illustrating the relationship between step surface 212 and central axis CA2.

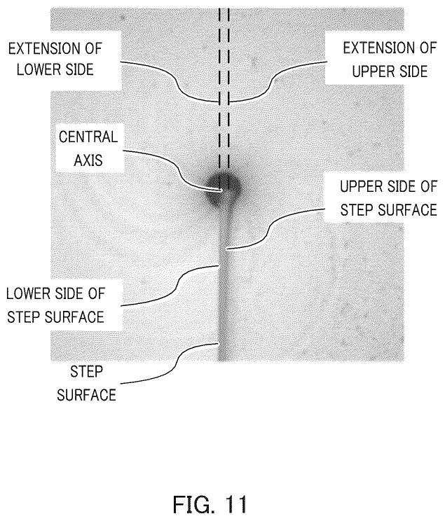

In view of this, in the present embodiment, when performing the radial cutting process of vortex surface molding surface 110 of metal mold 100, a cutting tool according to the present embodiment having a cutting edge with a vertical shape on one side is used instead of known cutting tool 130 having a cutting edge with a curved shape (R shape) on both sides. In this manner, as illustrated in FIG. 4B, at the upper end of step surface molding surface 112, the situation where curved surface (R surface) 112R is formed at the boundary between phase control surface molding surface 111 and step surface molding surface 112 can be suppressed. In this manner, the situation where the position of the upper side of step surface molding surface 112 and the position of the lower side of step surface molding surface 112 are shifted from each other in the horizontal direction can be suppressed, and the situation where the upper side and lower side of step surface molding surface 112 are separated away from central axis CA1 of metal mold 100 can also be suppressed. As a result, the shortest distance between the extension of the upper side of each of the plurality of step surface molding surfaces 112 and central axis CA1 of metal mold 100, and the shortest distance between the extension of the lower side of each of the plurality of step surface molding surfaces 112 and central axis CA1 of metal mold 100 are both within the range from 0 μm to 5 μm. In the case where light flux controlling member 200 is manufactured by using metal mold 100 formed with the cutting tool according to the present embodiment, the shortest distance between the extension of the upper side of each of the plurality of step surfaces 212 of light flux controlling member 200 and central axis CA2 of light flux controlling member 200, and the shortest distance between the extension of the lower side of each of the plurality of step surfaces 212 of light flux controlling member 200 and central axis CA2 of light flux controlling member 200 are both within the range from 0 μm to 5 μm (see FIG. 11). That is, the plurality of step surfaces 212 is formed to radially extend from central axis CA2 as designed.

Metal mold 100 according to the present embodiment may be manufactured by forming vortex surface molding surface 110 by radially cutting a metal mold preform (base material) around a predetermined point, for example. At this time, it is preferable to use the above-mentioned cutting tool according to the present embodiment.

The material of the metal mold preform (base material) is not limited, and may be selected from publicly known materials as necessary. Examples of the material of the metal mold preform (base material) include steel materials, zinc alloys, and aluminum alloys. It is preferable that the metal mold preform (base material) contains a steel material from a view point of durability.

For example, when forming vortex surface molding surface 110 through a cutting process, it suffices to set the center point of the vortex in one main surface of the metal mold preform (base material), and perform radial cutting toward that center. It is also possible to set the center point of the vortex in one main surface of the metal mold preform (base material), and perform radial cutting from that center. In either case, a plurality of grooves 113 radially disposed toward the center of the vortex may be formed in the outer periphery part of vortex surface molding surface 110 in some situation.

When forming phase control surface molding surface 111, the cutting is performed by changing the height of the tip end of the tool such that the depth of the groove adjacent to one groove 113 is deeper or shallower in the rotational direction of the vortex. For example, in the case where the cutting of grooves is performed sequentially in the clockwise direction such that the angle between adjacent grooves is 0.2 degrees in plan view, the cutting is performed such that a groove deeper or shallower than the groove formed first is formed at a position advanced by 0.2 degrees clockwise from the groove formed first. By performing this process continuously in the range of a predetermined angle (e.g., 90 degrees), phase control surface molding surface 111 is formed in the main surface of the metal mold preform (base material). The rotational direction of the vortex can be set as desired, and the cutting may be performed by changing the height of the tip end of the tool in accordance with the rotational direction.

When forming step surface molding surface 112, the cutting is performed with the cutting tool according to the present embodiment disposed such that the cutting edge with a vertical shape is located on the step surface molding surface 112 side (see FIG. 4B). In this manner, step surface molding surface 112 is formed in the main surface of the metal mold preform (base material). Note that step surface molding surface 112 may be parallel to central axis CA1, or may be slightly tilted with respect to central axis CA1 (releasing taper). In vortex surface molding surface 110 formed in the above-described manner, each

of the plurality of phase control surface molding surfaces 111 is a curved concave surface, and, in lateral see-through view, the curve extending from center portion 114 of vortex surface molding surface 110 to the outer periphery part has an inflection point at center portion 114 of vortex surface molding surface 110. Specifically, in the cross section including central axis CA1, the curve of the cross section of the phase control surface molding surface 111 has an inflection point at center portion 114 of vortex surface molding surface 110. More specifically, in the cross section including central axis CA1, in the region other than center portion 114 in vortex surface molding surface 110, phase control surface molding surface 111 has a smaller inclination (comes closer to the direction perpendicular to central axis CA1) as it goes toward central axis CA1, whereas in center portion 114 of vortex surface molding surface 110, phase control surface molding surface 111 has a larger inclination (a smaller angle to central axis CA1) as it goes toward central axis CA1. Note that this does not apply to the very vicinity of step surface molding surface 112 even in center portion 114 of vortex surface molding surface 110. As such, the inflection of phase control surface molding surface 111 is not illustrated in FIG. 3B.

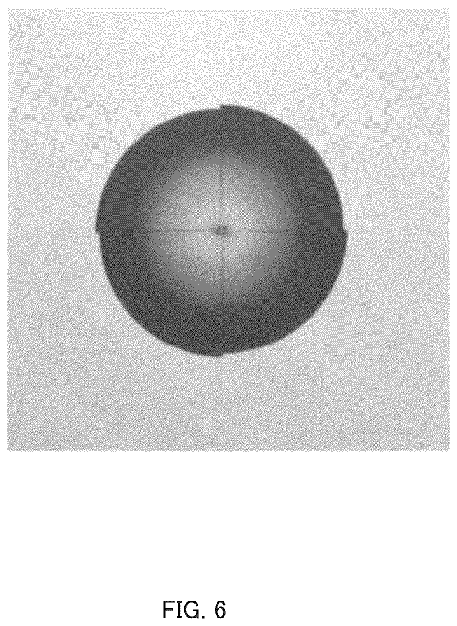

FIG. 6 is a photograph of metal mold 100 (vortex surface molding surface 110) manufactured as described above. FIG. 7 is a photograph of an enlarged center portion of vortex surface molding surface 110 (1000 times). As described above, by forming vortex surface molding surface 110 of metal mold 100 through the radial cutting process, center portion 114 of vortex surface molding surface 110 can be formed as a substantially mirrored surface. In addition, since vortex surface molding surface 110 is processed without continuously pressing the cutting tool against center portion 114 of vortex surface molding surface 110, the formation of large machining marks (crush) at the center portion of vortex surface molding surface 110 can be suppressed. Further, by using the cutting tool according to the present embodiment having a cutting edge with a vertical shape on one side, the situation where curved surface (R surface) 112R is formed at the boundary between phase control surface molding surface 111 and step surface molding surface 112 can be suppressed at the upper end of step surface molding surface 112. Thus, the upper sides of the plurality of step surface molding surfaces 112 intersect each other at center portion 114 of vortex surface molding surface 110. In addition, each of the plurality of phase control surface molding surfaces 111 is a curved concave surface, and, in lateral see-through view, the curve extending from center portion 114 of vortex surface molding surface 110 to the outer periphery part has an inflection point at center portion 114 of vortex surface molding surface 110. Further, the shortest distance between the extension of the upper side of each of the plurality of step surface molding surfaces 112 and central axis CA1 of metal mold 100, and the shortest distance between the extension of the lower side of each of the plurality of step surface molding surfaces 112 and central axis CA1 of metal mold 100 are both within the range from 0 μm to 5 μm.

### Light Flux Controlling Member and Manufacturing Method of The Same

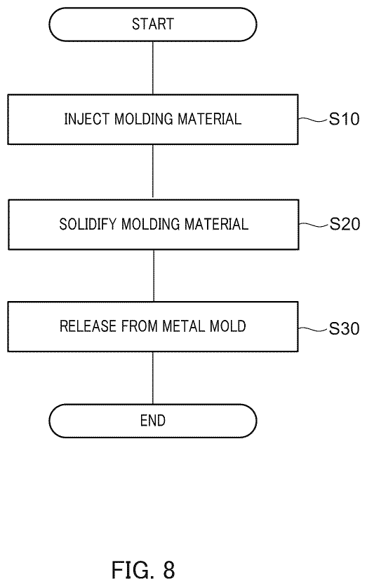

FIG. 8 is a flowchart of a manufacturing method of light flux controlling member 200 according to the present embodiment.

As illustrated in FIG. 8, the manufacturing method of light flux controlling member 200 according to the present embodiment includes: (1) a step of injecting a molding material into cavity 120 of metal mold 100 (step S10), (2) a step of solidifying the molding material inside cavity 120 (step S20), and (3) a step of releasing and removing the solidified molding material from metal mold 100 (step S30). Each step is described below.

First, a molding material is injected to cavity 120 of metal mold 100 (step S10). For example, metal mold 100 is used as a fixing side metal mold, and, after the fixing side metal mold is clamped with a movable side metal mold disposed opposite the fixing side metal mold, the molding material is injected from a molding material inlet.

In the present embodiment, a resin material may be used as the molding material. The type of the resin material may be appropriately selected from materials that are optically transparent to the light used. Examples of the resin material include polymethylmethacrylate (PMMA), polycarbonate (PC), epoxy resin (EP), modified polyphenylene ether (m-PPE), cycloolefin polymer (COP), and cyclic olefin copolymer (COC).

Next, the molding material injected to cavity 120 is solidified (step S20). For example, in the case where a thermoplastic resin has been injected to cavity 120, it suffices to cool and solidify the thermoplastic resin. In addition, in the case where a thermosetting resin has been injected to cavity 120, it suffices to heat and solidify (cure) the resin in cavity 120.

Finally, the molding material solidified at step S20 is released and removed from metal mold 100 (step S30).

Through the above-mentioned procedure, light flux controlling member 200 with vortex surface 210 with an inverted shape of the shape of vortex surface molding surface 110 of metal mold 100 can be manufactured. Now light flux controlling member 200 is described below.

FIGS. 9 and 10A to 10C are diagrams illustrating light flux controlling member 200 according to the present embodiment. FIG. 9 is a perspective view of light flux controlling member 200, FIG. 10A is a plan view of light flux controlling member 200, FIG. 10B is a front view, right view, rear view and left view of light flux controlling member 200, and FIG. 10C is a sectional view taken along line B-B and line C-C of FIG. 10A.

As illustrated in FIGS. 9 and 10A to 10C, light flux controlling member 200 includes vortex surface 210 and first surface 220.

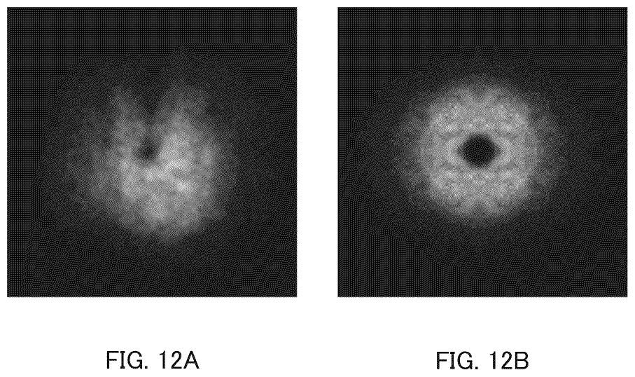

Vortex surface (light vortex generation surface) 210 includes the plurality of phase control surfaces 211 including a vortex shape around central axis CA2 and radially divided with respect to central axis CA2 at the center, and the plurality of step surfaces 212 each connecting the end portions of adjacent two phase control surfaces 211 in the plurality of phase control surfaces 211. Light passed through vortex surface 210 is converted to light that has a phase difference in the circumferential direction and has a ring-shaped intensity distribution (see FIG. 12B). In the present embodiment, as illustrated in FIG. 10A, vortex surface 210 (phase control surface 211) includes a plurality of ridges 213 corresponding to a plurality of working grooves 113 of metal mold 100. Note that in FIGS. 9 and 10B, the plurality of ridges 213 is omitted.

Each of the plurality of phase control surfaces 211 has a vortex shape around central axis CA2 of light flux controlling member 200. Here, the vortex shape may be a smooth, continuous vortex shape, or a stepwise vortex shape. The number of phase control surfaces 211 is not limited. In the present embodiment, vortex surface 210 includes the plurality of (four) phase control surfaces 211 the number of which is the same as the topological charge number 1 of vortex surface 210. The plurality of (four) phase control surfaces 211 is disposed to be symmetric (4-fold rotational symmetric) around central axis CA2. As such, the plurality of phase control surfaces 211 has the same shape, and is disposed in the same height range. Here, the height in light flux controlling member 200 means the position in the direction along central axis CA2.

Each of the plurality of phase control surfaces 211 is a convex surface, and the curve extending from center portion 214 of vortex surface 210 toward the outer periphery part has an inflection point at center portion 214 of vortex surface 210 in side view. Specifically, in the cross section including central axis CA2, the curve that is the cross section of phase control surface 211 has inflection point 215 at center portion 214 of vortex surface 210. More specifically, in the cross section including central axis CA2, in the region other than center portion 214 of vortex surface 210, phase control surface 211 has a smaller inclination (comes closer to the direction perpendicular to central axis CA2) as it goes toward central axis CA2, whereas in center portion 214 of vortex surface 210, phase control surface 211 has a larger inclination (a smaller angle to central axis CA2) as it goes toward central axis CA2 (see FIG. 10B). Note that this does not apply to the very vicinity of step surface 212 even in center portion 214 of vortex surface 210. As such, in FIG. 10C, the inflection of phase control surface 211 is not illustrated.

The plurality of step surfaces 212 each connect the end portions of adjacent two phase control surfaces 211. In the present embodiment, each of the plurality of step surfaces 212 is a flat surface extending in the radial direction to the outer edge from central axis CA2. The upper sides of the plurality of step surfaces 212 intersect each other at center portion 214 of vortex surface 210. The number of step surfaces 212 is the same as the number of phase control surfaces 211. For example, in the case where vortex surface 210 includes two phase control surfaces 211, vortex surface 210 includes two step surfaces 212, and each step surface 212 connects the end portions of adjacent two phase control surfaces 211. In the example of the present embodiment, vortex surface 210 includes four step surfaces 212. The plurality of (four) step surfaces 212 is disposed to be symmetric (4-fold rotational symmetric) around central axis CA2. Thus, the plurality of (four) step surfaces 212 has the same shape, and is disposed in the same height range.

The sum of the heights of the plurality of step surfaces 212 may be appropriately set in accordance with topological charge number 1 related to vortex light to be converted from Gaussian light. The sum of heights d of the plurality of step surfaces 212 can be obtained from the following Equation 1 where 1 is the topological charge number, λ is the wavelength of light passing through vortex surface 210, and Δn is the difference in refractive index for light wavelength λ between the material of light flux controlling member 200 and the medium (e.g., air) of the surrounding region. The sum of heights d of the plurality of step surfaces 212 is set in accordance with the topological charge number 1 to be provided, and is within a range from 1 μm to 10 μm, for example.

d=1×λ/Δn (Equation 1)

The plurality of ridges 213 is a pattern transferred from the plurality of working grooves 113 of metal mold 100. As illustrated in FIG. 10A, the plurality of ridges 213 is disposed radially from central axis CA2 in vortex surface 210. As such, the plurality of ridges 213 is disposed such that the closer to central axis CA2, the smaller the distance between adjacent ridges 213, to finally overlap each other. The groove formed between adjacent ridges 213 also correspondingly becomes shallower as it goes toward central axis CA2. Thus, the height of ridge 213 decreases as it goes toward the center. In this manner, center portion 214 of vortex surface 210 is formed as a substantially mirrored surface. Here “the height of ridge 213” does not mean the absolute height of ridge 213 (e.g., the height with respect to first surface 220), but means the height with respect to the bottoms of the grooves on both sides of ridge 213.

Light flux controlling member 200 according to the present embodiment may be manufactured by using metal mold 100 according to the present embodiment. As described above, in metal mold 100 according to the present embodiment, the upper sides of the plurality of step surface molding surfaces 112 intersect at center portion 114 of vortex surface molding surface 110, and the shortest distance between the extension of the upper side of each of the plurality of step surface molding surfaces 112 and central axis CA1 of metal mold 100, and the shortest distance between the extension of the lower side of each of the plurality of step surface molding surfaces 112 and central axis CA1 of metal mold 100 are both within the range from 0 μm to 5 μm. Accordingly, also in light flux controlling member 200 according to the present embodiment, the upper sides of the plurality of step surfaces 212 intersect each other at center portion 214 of vortex surface 210, and the shortest distance between the extension of the upper side of each of the plurality of step surfaces 212 and central axis CA2 of light flux controlling member 200, and the shortest distance between the extension of the lower side of each of the plurality of step surfaces 212 and central axis CA2 of light flux controlling member 200 are both within the range from 0 μm to 5 μm. That is, step surface 212 is formed to radially extend from central axis CA2 as designed.

FIG. 11 is a photograph of a region near the center of vortex surface 210 in light flux controlling member 200 according to the present embodiment. Here, vortex surface 210 with one step surface 212 is illustrated for the sake of clearly illustrating the relationship between step surface 212 and central axis CA2. In FIG. 11, it is clear that the upper side and lower side of step surface 212 are not separated from the central axis (the center of the vortex) (see FIG. 5 for comparison). In the example illustrated in FIG. 11, the shortest distance between the extension of the upper side of step surface 212 and central axis CA2 of light flux controlling member 200, and the shortest distance between the extension of the lower side of step surface 212 of light flux controlling member 200 and central axis CA2 of light flux controlling member 200 are both 1 μm or smaller.

FIG. 12A is a diagram illustrating an intensity distribution of light emitted from light flux controlling member 200 having vortex surface 210 with a crushed center portion as that illustrated in FIG. 5, and FIG. 12B is a diagram illustrating an intensity distribution of light emitted from light flux controlling member 200 according to the present embodiment. Each drawing illustrates an intensity distribution of light at the focal point position of light flux controlling member 200. As illustrated in FIG. 12B, light flux controlling member 200 according to the present embodiment can generate light with a desired ring-shaped intensity distribution.

Vortex surface 210 of light flux controlling member 200 according to the present embodiment is preferably n-fold rotational symmetry (n is an integer of 2 or more), and n is preferably the same number as topological charge number 1 of vortex surface 210. For example, in the case where topological charge number 1 is four, it is preferable that vortex surface 210 be 4-fold rotational symmetry, i.e., include four phase control surfaces 211 with the same shape and four step surfaces 212 with the same shape as illustrated in FIGS. 9 and 10A. Four phase control surfaces 211 and four step surfaces 212 are disposed in the same height range. This results in a small difference in thickness in light flux controlling member 200, which suppresses the stress distortion during the cutting process of metal mold 100 and the molding of light flux controlling member 200, and improves the molding accuracy of light flux controlling member 200.

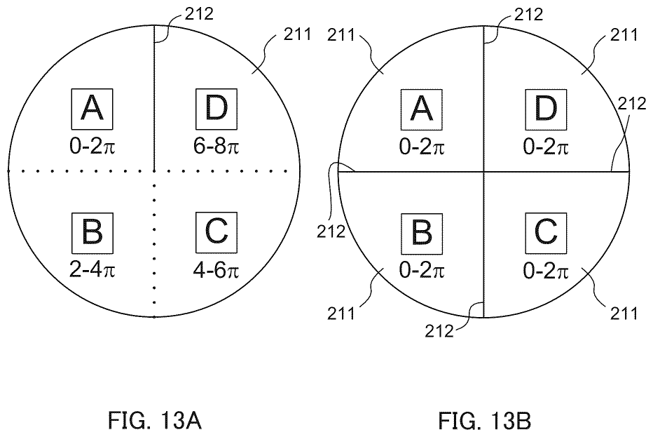

FIGS. 13A and 13B are schematic plan views illustrating vortex surface 210 of light flux controlling member 200 of which topological charge number 1 is four. Vortex surface 210 illustrated in FIG. 13A includes one phase control surface 211 and one step surface 212. On the other hand, vortex surface 210 illustrated in FIG. 13B includes four phase control surfaces 211 and four step surfaces 212. It is assumed here that vortex surface 210 is divided into four regions A to D as illustrated in FIGS. 13A and 13B. In vortex surface 210 illustrated in FIG. 13A, region A corresponds to a phase difference ΔΦ of 0 to 2π, region B to a phase difference ΔP of 2 to 4π, region C to a phase difference ΔΦ of 4 to 6π, and region D to a phase difference ΔΦ of 6 to 8π. In vortex surface 210 illustrated in FIG. 13A, step surface 212 is present only between region A and region D, and this step surface 212 has a height of 5.2 μm (=1.3 μm×4), for example. On the other hand, in vortex surface 210 illustrated in FIG. 13B, each of regions A to D corresponds to a phase difference ΔΦ of 0 to 2π. In vortex surface 210 illustrated in FIG. 13B, step surface 212 is present between region A and region B, between region B and region C, between region C and region D, and between region D and region A, the heights of these step surfaces 212 are each 1.3 μm (total height: 5.2 μm), for example. As such, in light flux controlling member 200 illustrated in FIG. 13A, the difference of the thickness of the portion adjacent to step surface 212 is as large as 5.2 μm, whereas in light flux controlling member 200 illustrated in FIG. 13B, the difference of the thickness of the portion adjacent to step surface 212 is as small as 1.3 μm. As described above, in light flux controlling member 200 illustrated in FIG. 13B, the difference of the thickness in light flux controlling member 200 is small, which suppresses the stress distortion during the cutting process of metal mold 100 and the molding of light flux controlling member 200, and improves the molding accuracy of light flux controlling member 200.

### Effects

As described above, in the present embodiment, vortex surface molding surface 110 of metal mold 100 is formed by performing radial cutting, and thus center portion 114 of vortex surface molding surface 110 can be formed as a substantially mirrored surface. In addition, since vortex surface molding surface 110 is processed without continuously pressing the cutting tool against center portion 114 of vortex surface molding surface 110, the formation of large machining marks (crush) at center portion 114 of vortex surface molding surface 110 can be suppressed. Further, by using the cutting tool according to the present embodiment having a cutting edge with a vertical shape on one side, the situation where curved surface (R surface) 112R is formed at the boundary between phase control surface molding surface 111 and step surface molding surface 112 at the lower end of step surface molding surface 112 can be suppressed. As a result, light flux controlling member 200 according to the present embodiment can generate light with a desired ring-shaped intensity distribution.

### Modification

Note that while light flux controlling member 200 including one vortex surface 210 is described in the present embodiment, the light flux controlling member according to the present invention may be a lens array including a plurality of vortex surfaces 210.

In addition, the light flux controlling member according to the present invention may be a light flux controlling member including vortex surface (second surface) 210 serving as an incidence surface and first surface 220 serving as an emission surface, or a light flux controlling member including a first surface 220 serving as an incidence surface and vortex surface (second surface) 210 serving as an emission surface.

### INDUSTRIAL APPLICABILITY

According to the present invention, a light flux controlling member that can appropriately form light with a ring-shaped intensity distribution can be provided. The light flux controlling member according to the present invention is suitable for optical communications and the like, for example.

### REFERENCE SIGNS LIST

100 Metal mold
101 Upper mold
102 Lower mold
110 Vortex surface molding surface
111 Phase control surface molding surface
112 Step surface molding surface
112 R curved surface
113 Working groove
114 Center portion of vortex surface molding surface
120 Cavity
121 Gate
130 Known cutting tool
200 Light flux controlling member
210 Vortex surface (Second surface)
211 Phase control surface
212 Step surface
213 Ridge
214 Center portion of vortex surface
215 Inflection point of phase control surface
220 First surface
CA1 Central axis of metal mold
CA2 Central axis of light flux controlling member

1. A light flux controlling member comprising:
a vortex surface including a plurality of phase control surfaces having a vortex shape around a central axis and radially divided with the central axis at a center, and a plurality of step surfaces each configured to connect end portions of adjacent two phase control surfaces of the plurality of phase control surfaces,
wherein upper sides of the plurality of step surfaces intersect each other at a center portion of the vortex surface; and
wherein in side view, a curve extending from the center portion toward an outer periphery part of the vortex surface has an inflection point at the center portion of the vortex surface.

2. The light flux controlling member according to claim 1, wherein a shortest distance between an extension of an upper side of each of the plurality of step surfaces and the central axis, and a shortest distance between an extension of a lower side of each of the plurality of step surfaces and the central axis are both 5 μm or smaller.

3. The light flux controlling member according to claim 1, wherein the number of the plurality of phase control surfaces is the same as a topological charge number of the vortex surface.

4. The light flux controlling member according to claim 1, wherein the plurality of phase control surfaces has the same shape.

5. The light flux controlling member according to claim 1, wherein the plurality of phase control surfaces is disposed in a same height range.

6. A metal mold for molding a light flux controlling member, the light flux controlling member comprising:
a vortex surface including a plurality of phase control surfaces having a vortex shape around a central axis and radially divided with the central axis at a center, and a plurality of step surfaces each configured to connect end portions of adjacent two phase control surfaces of the plurality of phase control surfaces,
wherein upper sides of the plurality of step surfaces intersect each other at a center portion of the vortex surface; and
wherein in side view, a curve extending from the center portion toward an outer periphery part of the vortex surface has an inflection point at the center portion of the vortex surface.
